(19) United States
(12) Patent Application Publication
(10) Pub. No.: US 2026/0348450 A1
(43) Pub. Date: Nov. 5, 2026

(54) REDUCTION GEAR WITH A WORM SCREW AND WORM WHEEL FOR A SOLAR TRACKER

(71) Applicant: SOLTEC INNOVATIONS, S.L., Molina de Segura (ES)

(72) Inventors: Alonso MOLINA CANO, Molina de Segura (ES); Luis CRUZ REVERTE, Molina de Segura (ES); Marta GARCÍA VIVANCOS, Molina de Segura (ES); Ignacio MELÓN MENÉNDEZ, Molina de Segura (ES)

(73) Assignee: SOLTEC INNOVATIONS, S.L., Molina de Segura (ES)

(21) Appl. No.: 19/486,946

(22) PCT Filed: May 16, 2024
(86) PCT No.: PCT/ES2024/070294

§ 371 Date: Nov. 23, 2025

(30) Foreign Application Priority Data
May 22, 2023 (ES) U202330882

(51) Int. Cl. F16H 1/16; F16H 57/03; F16H 57/032; H02S 20/32

(52) U.S. Cl. CPC F16H 1/16; F16H 57/03; F16H 57/032; H02S 20/32

(57) ABSTRACT

A reduction gear includes a worm screw; a worm wheel, meshed with the worm screw; and a casing in which the worm screw and the worm wheel are housed. The casing is made of sheet metal material. The casing may include an outer shell formed by one or more pieces of sheet metal, that are preferably connected to one another. The casing of sheet metal provides reduced weight, greater dimensional precision, simplified method of manufacture and reduced material.

### TECHNICAL FIELD

The present invention is included within the field of solar energy solar installations, particularly in solar tracker components. More specifically, the object of the invention relates to a reduction gear of the worm screw and worm wheel type, for a solar tracker.

### BACKGROUND

A solar tracker provides the panels of a solar installation, for example a photovoltaic installation, with a rotation that allows the panels to face the sun as orthogonally as possible throughout the daylight hours in order to efficiently take advantage of the incident solar energy on the panels.

Solar trackers have a longitudinal structure with various configurations that defines a longitudinal direction with respect to which it is rotational. The panels are assembled on the structure in various possible ways so that the longitudinal rotation of the structure drives the panels so as to provide said panels with solar tracking.

The rotation of the longitudinal structure is produced by a reduction gear and geared motor assembly, wherein the geared motor jointly integrates a motor and a reduction system based on gears to gear down the rotation of the motor, and the reduction gear also incorporates a worm screw connected to the reduction system and a worm wheel connected to the worm screw and to the longitudinal structure. The rotation of the motor is first geared down by the reduction system and transferred to the worm screw of the reduction gear, wherein it continues its gearing down through the worm wheel, which transfers it to the longitudinal structure to cause the rotation of the panels.

The reduction gear further comprises a casing that houses the worm screw and the worm wheel. The casing is usually made of iron alloys commonly referred to as “cast iron” or “casting”.

Trackers are usually supported on jacks, which are metal posts driven into the ground, where one or more reduction gears are arranged in corresponding jacks to transmit rotation to the longitudinal structure and, therefore, to the panels, generating solar tracking.

### Description of the Invention

The present invention relates to a reduction gear with a worm screw and worm wheel for a solar tracker, which is characterized by comprising a casing made of sheet metal material, for example, pressed metal, instead of casting material, in which a worm screw and a worm wheel meshed with the worm screw are housed.

The casing made of sheet metal provides, for similar levels of mechanical properties, such as stress resistance, reduced weight and greater dimensional precision, as well as a simplified method of manufacture, since the necessary machining processes are reduced or eliminated, and therefore, the production times for the finished product are reduced with respect to cast iron casings. On the other hand, the environmental impact is reduced (it is not necessary to reach casting temperatures) in comparison with a casing made of cast iron. The greater dimensional precision obtained, in turn, contributes to facilitating reduction gear assembly tasks, as well as to standardizing packaging and transport, since the pieces could be more stackable with respect to one another, while the reduced weight contributes, on one hand, to optimizing transport costs, and on the other hand, to improving operator ergonomics, and therefore safety, during the manufacturing, mounting and final assembly tasks in the field, which results in a reduction of the necessary human effort for the assembly.

### BRIEF DESCRIPTION OF THE FIGURES

The foregoing and other advantages and features will be more fully understood from the following detailed description of exemplary embodiments with reference to the accompanying drawings, which should be considered by way of illustration and not limitation, wherein:

FIG. 1 shows a perspective view of a cast iron reduction gear according to the state of the art.

FIG. 2 shows a section view through a central plane of the reduction gear of FIG. 1.

FIG. 3 is a perspective view of a reduction gear made of sheet metal according to the present invention.

FIG. 4 shows a section view through a central plane of the reduction gear of FIG. 3.

### LIST OF REFERENCES

1 Reduction gear
2 Worm screw
3 Worm wheel
4 Casing
5 Outer shell
6 Additional pieces

### DETAILED DESCRIPTION OF AN EXEMPLARY EMBODIMENT

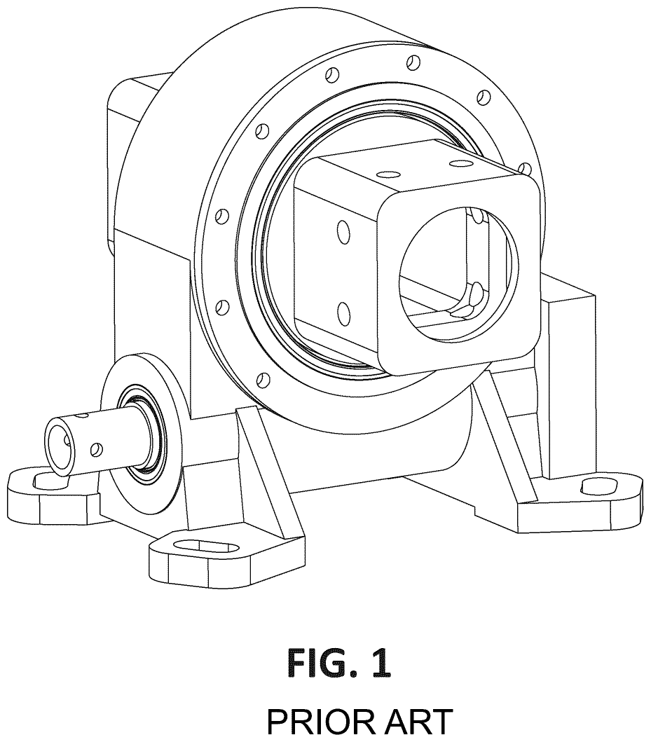

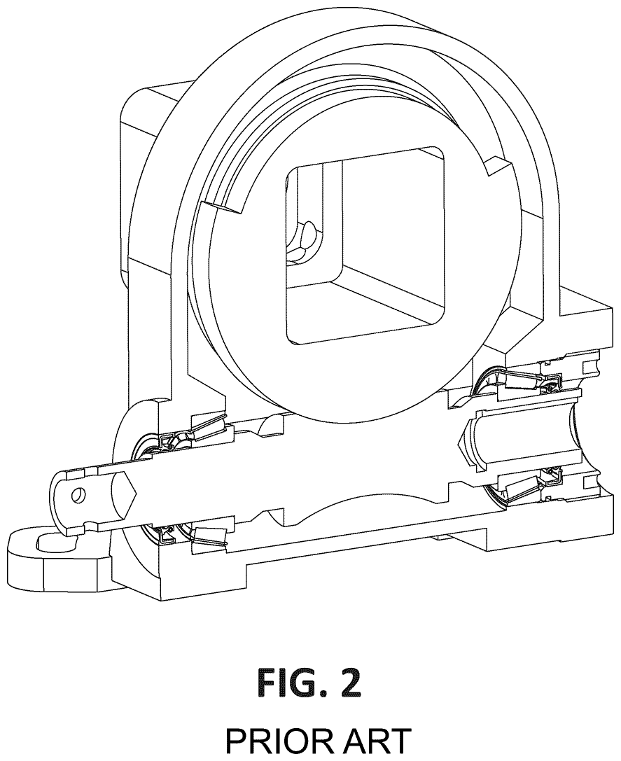

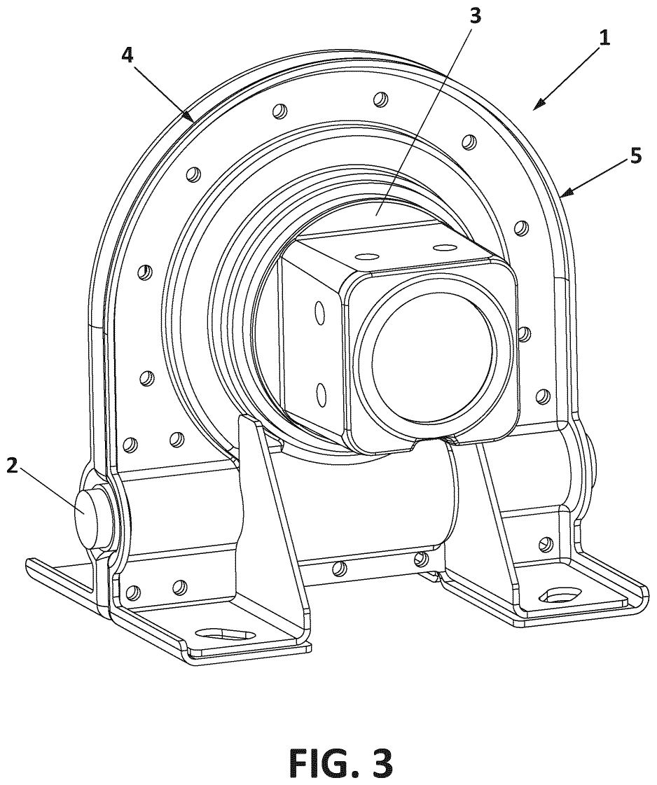

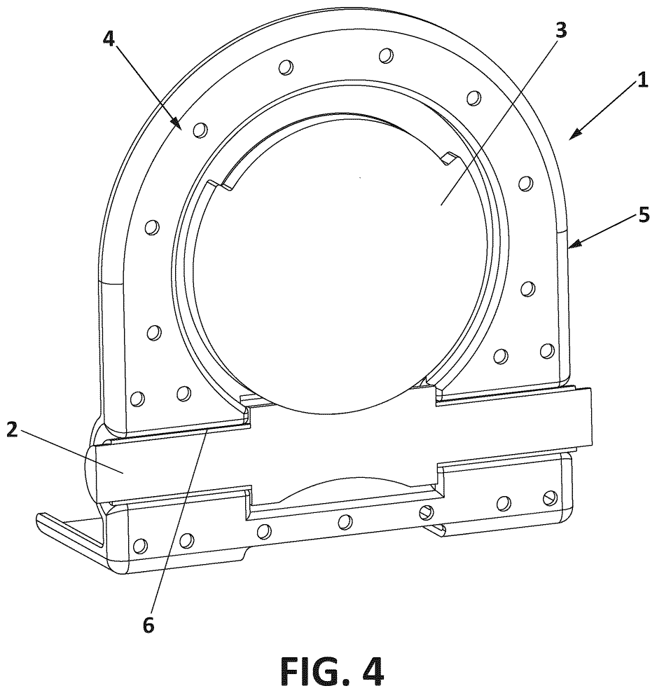

Next, with the aid of the attached FIGS. 1-4 mentioned above, a detailed description of a preferred exemplary embodiment of a gearbox (1) with a worm screw (2) and worm wheel (3) for a solar tracker is provided, wherein the reduction gear (1) constitutes the object of the present invention. The tracker can be a general purpose solar tracker, although a photovoltaic solar tracker is proposed as a more representative, non-limiting example.

The worm screw (2) is intended to be connected to the output of a motor system (not shown), such as a motor or a geared motor, to transmit the rotation of the motor system to the worm wheel (3). In turn, the worm wheel (3) is assembled meshing with the worm screw (2) to transmit the rotation and gear it down even more depending on its transmission ratio, and it is also intended to be connected with a longitudinal structure (not shown), for example, a torsion shaft of the solar tracker, to transfer to said longitudinal structure the geared down rotation, through which the rotation is provided to the panels of the tracker for solar tracking. The reduction gear (1) also comprises a casing (4) in which the worm screw (2) and the worm wheel (3) are housed. The casing (4) is made of sheet metal, preferably pressed metal, although it can also be sheet metal formed by any other means. More specifically, the casing (4) comprises an outer shell (5) made up of one or more pieces of sheet metal, preferably pressed metal, or as just indicated, manufactured by any other sheet metal transformation process, if applicable, connected to each other either reversibly (for example, screwed together), or irreversibly (for example, by means of welding, riveting, etc.). The casing (4) can include additional pieces (6) with various functions (a structural function, such as stiffening, and/or a non-structural function, such as forming seats to house and/or support other elements, such as the worm screw (2) and/or the worm wheel (3), etc.), and which are not necessarily made up of sheet metal, but they can be manufactured by other methods, such as by machining, with chip removal. Some of the additional pieces with a structural function can additionally be used with a non-structural function. The additional pieces (6) can be linked to the outer shell (5), for example: they can be connected to the outer shell (5) or they can be supported, such as by contact or pressure, by the outer shell (5).

1.-13. canceled

14. A solar tracker assembly comprising:
a rotatable support structure configured to carry one or more solar panels;
a motor system configured to impart rotational motion to the support structure; and
a reduction gear operatively coupled between the motor system and the support structure, the reduction gear comprising:
a worm screw configured to receive rotational input from the motor system;
a worm wheel meshed with the worm screw and configured to transmit a geared-down rotation to the support structure; and
a casing housing the worm screw and the worm wheel,
wherein the casing is formed from sheet-metal material instead of a cast material.

15. The solar tracker assembly of claim 14, wherein the casing comprises an outer shell formed from one or more pressed sheet-metal components joined to one another by welding, riveting, or threaded fastening.

16. The solar tracker assembly of claim 15, further comprising at least one auxiliary piece linked to the outer shell, the auxiliary piece providing structural stiffening or defining a seat configured to support the worm screw or the worm wheel.

17. The solar tracker assembly of claim 16,
wherein the auxiliary piece is made of a material different from sheet metal, including a machined or cast component,
wherein the auxiliary piece is an additional pieces separate from the casing and linked, connected, or supported to the casing.

18. The solar tracker assembly of claim 16, wherein the auxiliary piece provides structural reinforcement that stiffens the casing.

19. The solar tracker assembly of claim 14, wherein the reduction gear is mounted on a jack-supported longitudinal shaft configured to rotate the solar panels.

20. The solar tracker assembly of claim 14, wherein the sheet-metal casing is manufactured by pressing or stamping sheet-metal parts to form the outer shell.

21. The solar tracker assembly of claim 14, wherein the sheet-metal casing provides reduced weight, greater dimensional precision, and reduced manufacturing time relative to a cast-iron casing.

22. A reduction gear for a solar tracker, the solar tracker having a rotatable support structure configured to carry one or more solar panels and a motor system configured to impart rotational motion to the support structure; the reduction gear comprising:
a worm screw;
a worm wheel meshed with the worm screw; and
a casing housing the worm screw and the worm wheel, the casing is adapted to be housed in jacks of the solar tracker to transmit rotation to the longitudinal structure;
wherein the casing is formed from sheet-metal material instead of a cast material.

23. A method of manufacturing a reduction gear for a solar tracker, the solar tracker having a rotatable support structure configured to carry one or more solar panels and a motor system configured to impart rotational motion to the support structure; the method comprising the steps of:
forming a casing by pressing one or more sheet-metal parts;
assembling within the casing a worm screw and a worm wheel in meshed engagement; and
coupling the assembled reduction gear to a rotatable support structure of a solar tracker.
